(19) United States
(12) Patent Application Publication
(10) Pub. No.: US 2022/0058312 A1
(43) Pub. Date: Feb. 24, 2022

(54) ESTIMATION APPARATUS, OPTIMIZATION APPARATUS, ESTIMATION METHOD, OPTIMIZATION METHOD, AND PROGRAM

(71) Applicant: NIPPON TELEGRAPH AND TELEPHONE CORPORATION, Tokyo (JP)

(72) Inventors: Tomoharu IWATA, Tokyo (JP); Takuma OTSUKA, Tokyo (JP)

(73) Assignee: NIPPON TELEGRAPH AND TELEPHONE CORPORATION, Tokyo (JP)

(21) Appl. No.: 17/299,712

(22) PCT Filed: Nov. 22, 2019
(86) PCT No.: PCT/JP2019/045849

§ 371 Date: Jun. 3, 2021

(30) Foreign Application Priority Data
Dec. 7, 2018 (JP) 2018-229988

(51) Int. Cl. G06F 30/20; G06F 17/10

(52) U.S. Cl. CPC G06F 30/20; G06F 2111/10; G06F 17/10

(57) ABSTRACT

An estimation apparatus includes an input unit configured to input data related to a plurality of optimization problems, and an estimation unit configured to estimate a parameter of a function model that models a function to be optimized in each of the plurality of optimization problems. Additionally, the optimization apparatus includes an input unit configured to input a function model that models a function to be optimized in each of a plurality of optimization problems, and an optimization unit configured to optimize a target function by repeatedly evaluating the target function to be optimized in an optimization problem different from each of the plurality of optimization problems, using the function model.

### TECHNICAL FIELD

The present disclosure relates to an estimation apparatus, an optimization apparatus, an estimation method, an optimization method, and a program.

### BACKGROUND ART

An optimization problem is a problem of finding a point taking a maximum value or a point taking a minimum value of a function. Here, there is a case where a plurality of related optimization problems is given. For example, there are the problem of finding an optimal machine learning device in each of a plurality of data sets, the problem of finding optimal human flow navigation in each of different situations, the problem of finding the optimal parameters of a simulator in each of different situations, or the like.

Additionally, Bayesian optimization is known as one of the optimization methods for solving the optimization problem (for example, see Non Patent Literature 1). Bayesian optimization is an optimization method to find a point taking the maximum value or a point taking the minimum value of a non-shaped function (black box function).

### CITATION LIST

### Non Patent Literature

Non-Patent Literature 1: Jasper Snoek, Hugo Larochelle, and Ryan P. Adams. “Practical Bayesian optimization of machine learning algorithms.” Advances in Neural Information Processing Systems. 2012.

### SUMMARY OF THE INVENTION

### Technical Problem

However, in a case where a plurality of related optimization problems are given, Bayesian optimization did not leveraged knowledge of other related optimization problems. In other words, in a case where a certain optimization problem is solved by Bayesian optimization, information related to other optimization problems could not be leveraged. Accordingly, there was a case where the optimization problems cannot be solved efficiently.

The present disclosure is made in view of the foregoing, and an object thereof is to efficiently solve a plurality of optimization problems.

### Means for Solving the Problem

To achieve the object described above, an estimation apparatus according to an embodiment of the present disclosure includes an input unit configured to input data related to a plurality of optimization problems, and an estimation unit configured to estimate a parameter of a function model that models a function to be optimized in each of the plurality of optimization problems.

Additionally, an optimization apparatus according to the embodiment of the present disclosure includes an input unit configured to input a function model that models a function to be optimized in each of a plurality of optimization problems, and an optimization unit configured to optimize a target function by repeatedly evaluating the target function to be optimized in an optimization problem different from each of the plurality of optimization problems, using the function model.

### Effects of the Invention

A plurality of optimization problems can be solved efficiently.

### BRIEF DESCRIPTION OF DRAWINGS

FIG. 1 is a diagram illustrating an example of a functional configuration of an estimation apparatus and an optimization apparatus according to an embodiment of the present disclosure.

FIG. 2 is a diagram illustrating an example of a hardware configuration of the estimation apparatus and the optimization apparatus according to the embodiment of the present disclosure.

FIG. 3 is a flowchart illustrating an example of parameter estimation processing according to the embodiment of the present disclosure.

FIG. 4 is a flowchart illustrating an example of optimization processing according to the embodiment of the present disclosure.

### DESCRIPTION OF EMBODIMENTS

Hereinafter, an embodiment according to the present disclosure will be described. The embodiment of the present disclosure describes an estimation apparatus 10 and an optimization apparatus 20 to efficiently solve optimization problems in a case where a plurality of the optimization problems are given.

In the embodiment of the present disclosure, it is assumed that data related to D optimization problems,

{{x_{dn},y_{dn}}ₙ₌₁^{N}^{_{d}},r_{d}}_{d=1}^{D} [Math. 1]

is given. Hereinafter, the D optimization problems are also represented as “original problems”. Additionally, each of the original problems is represented as a “problem d” (d=1, . . . , D), and the data related to the original problem is also represented as “original problem data”. Here,

x_{dn}∈ [symbol] ^{M} [Math. 2]

is the n-th input vector of problem d:

y_{dn}=f_{d}(x_{dn})+ϵ [Math. 3]

is an output value, f_{d}(⋅) is a function to be optimized in the problem d, ε is an observation noise, and N_{d} is the number of observation data in the problem d; and

r_{d}∈ [symbol] ^{S} [Math. 4]

represents a feature of the problem d. Hereinafter, for convenience, in the text of the disclosure, a vector is not bold, but is represented in a normal typeface. For example, the feature illustrated in Math. 4 above is represented as “r_{d}” in the text of the disclosure.

At the time, in a case where the feature r_{d*} of an optimization problem different from each of the original problems (also representing the optimization problem as “target problem d*”) is given, the maximum value of the function f_{d}·(x) of the target problem d* is obtained with a smaller number of evaluations based on the framework of the Bayesian optimization, that is, a point taking the maximum value (vector),

$${argmax}_{x} {f}_{{d}^{*}} ( x ) \qquad [ Math . 5 ]$$

is obtained. Hereinafter, the function to be evaluated (that is, the function f_{d*} described above) in the framework of the Bayesian optimization is represented as a “target function”.

In the embodiment of the present disclosure, the parameter of the model of the function f_{d} to be optimized (hereinafter, also represented as a “function model”) is estimated by the estimation apparatus 10 using the original problem data. Then, using the function model for which the parameter is set, the target problem is optimized by the optimization apparatus 20 based on the Bayesian estimation framework. Accordingly, it is possible to optimize the target problem with a smaller number of evaluations and it is possible to efficiently solve the original problem and the target problem, that is, a plurality of optimization problems.

In the embodiment of the present disclosure, although a case where the feature of the optimization problem (the r_{d} and the r_{d*} described above) is given will be described, the feature may not be given. Additionally, in the embodiment of the present disclosure, although a case where a target problem is optimized in a situation in which an original problem is given, is described, the present disclosure can also be applied in the same manner, for example, in a case where a given plurality of optimization problems are simultaneously optimized.

Additionally, in the embodiment of the present disclosure, although a case where the maximum value of the target function f_{d*} is obtained, is described (that is, in a case where the target problem is a maximizing problem), the present disclosure can also be applied in the same manner in a case where the minimum value of the target function f_{d*} is obtained (that is, in a case where the target problem is a minimizing problem).

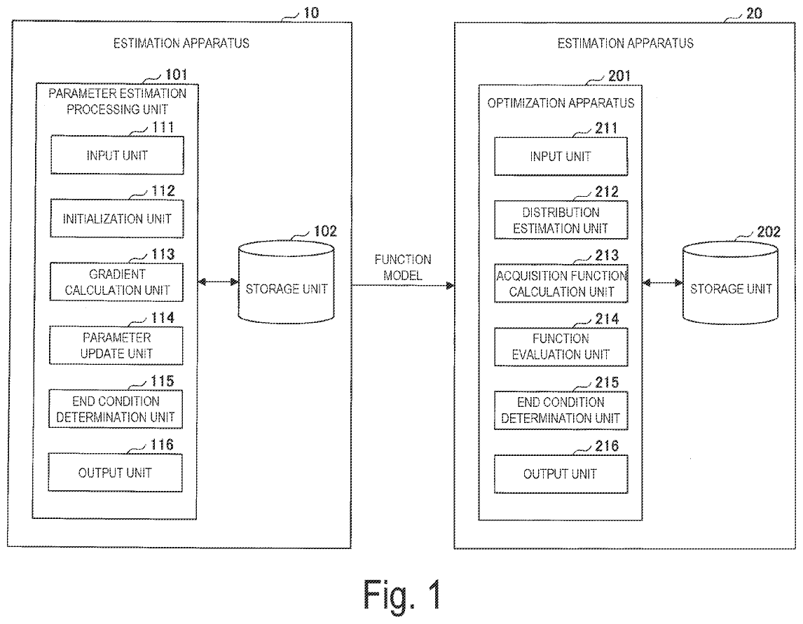

Functional configuration of estimation apparatus 10 and optimization apparatus 20 First, the functional configuration of the estimation apparatus 10 and the optimization apparatus 20 according to the embodiment of the present disclosure will be described with reference to FIG. 1. FIG. 1 is a diagram illustrating an example of a functional configuration of the estimation apparatus 10 and the optimization apparatus 20 according to the embodiment of the present disclosure.

Estimation Apparatus 10

As illustrated in FIG. 1, the estimation apparatus 10 according to an embodiment of the present disclosure includes a parameter estimation processing unit 101, and a storage unit 102.

The parameter estimation processing unit 101 executes processing to estimate a parameter of a function model (hereinafter, also represented as “parameter estimation processing”). The storage unit 102 stores various data used in the parameter estimation processing (for example, the original problem data, or the like) and a processing result of the parameter estimation processing (for example, the parameter of the function model, or the like).

Here, the parameter estimation processing unit 101 models the function f_{d}(⋅) of each problem d by the neural Gaussian process illustrated in the following Equation (1) (that is, it is assumed that the neural Gaussian process illustrated in the following Equation (1) is a function model).

[Math. 6]

f_{d}(x)˜ [symbol] (m(x,r_{d};ξ),k(g(x,r_{d}ψ),g(x′,r_{d};ψ);θ) (1)

Here,

[symbol]

(m,k) [Math. 7]

is the Gaussian process of an average function m and a kernel function k; m(⋅; ξ) is an average function defined by a neural network having a parameter ξ; k(⋅, ⋅; θ) is a kernel function having a parameter θ; and g(⋅; ψ) represents a neural network having a parameter ψ. The parameters ξ, θ, and ψ are each represented by a vector and are shared among all the problems d. Instead of the Gaussian process, any model that generates a function may be used, for example, a Student-t process or the like.

Any neural network such as a feed-forward type, a convolutional type, and a recursive type can be used as the neural network. Additionally, other models may also be used instead of a neural network.

At the time, the parameter estimation processing unit 101 estimates the parameters ξ, θ, and ψ so that the original problem data can be described by the function model illustrated in Equation (1) above. The parameter estimation processing unit 101 estimates the parameters ξ, θ, and ψ by maximizing an objective function, for example, using the likelihood illustrated in Equation (2) below as the objective function.

$$\begin{matrix} [ Math . 8 ] & \\ L ( ξ , ψ , θ , β ) = - \frac{1}{2} {\sum }_{d = 1}^{D} ( {N}_{d} log 2π + log \vert {K}_{d} + β I \vert + {( {y}_{d} - {m}_{d} )}^{⊤} {( {K}_{d} + β I )}^{- 1} ( {y}_{d} - {m}_{d} ) ) & ( 2 )\end{matrix}$$

Here

y_{d}=(y_{dn})ₙ₌₁^{N}^{_{d}} [Math. 9]

is a vector of an output value of an N_{d} dimension of the problem d;

m_{d}=(m(x_{dn},r_{d};ξ))ₙ₌₁^{N}^{_{d}} [Math. 10]

is a vector of an average function value for the N_{d} dimension of the problem d; and K_{d} is a kernel matrix of the problem d of N_{d}×N_{d}, in which the (n, n′) element is a matrix given by

k(g(x_{dn},r_{d};ψ),g(x_{dn′},r_{d};ψ);θ)). [Math. 11]

In a case where the feature r_{d} is not given to each of the problems d, the feature r_{d} may not be taken as the input of the neural network. That is, m(x, ξ) may be used instead of m(x, r_{d}; ξ), and g(x,; ψ) may be used instead of g(x, r_{d}; ψ).

Here, as illustrated in FIG. 1, the parameter estimation processing unit 101 includes an input unit 111, an initialization unit 112, a gradient calculation unit 113, a parameter update unit 114, an end condition determination unit 115, and an output unit 116.

The input unit 111 inputs the original problem data. The input unit 111 may input the original problem data stored in the storage unit 102, or may receive and input the original problem data from other apparatuses connected via the communication network.

The initialization unit 112 initializes the parameter of the function model (for example, the parameters ξ, θ, and ψ described above). The gradient calculation unit 113 calculates a gradient of the objective function (for example, the likelihood illustrated in Equation (2) above). The parameter update unit 114 updates the parameter of the function model so that the value of the objective function increases using the gradient calculated by the gradient calculation unit 113.

The calculation of the gradient by the gradient calculation unit 113 and the updating of the parameter by the parameter update unit 114 are repeatedly executed until a predetermined end condition is satisfied. Hereinafter, the predetermined end condition is represented as a “first end condition”.

The end condition determination unit 115 determines whether the first end condition is satisfied. The first end condition includes, for example, that the number of repetitions described above reaches a predetermined number, that the change quantity of the objective function value is less than or equal to a predetermined threshold value, that the change quantity of the parameter is less than or equal to a predetermined threshold value before and after updating, or the like.

In a case where the end condition determination unit 115 determines that the first end condition is satisfied, the output unit 116 outputs the parameter of the function model. The output unit 116 may output (store) the parameter of the function model to the storage unit 102, or may output to other apparatuses (for example, the optimization apparatus 20, or the like) connected via the communication network. Hereinafter, the parameter output by the output unit 116 is also represented as an “estimated parameter”.

Optimization Apparatus 20

As illustrated in FIG. 1, the optimization apparatus 20 according to the embodiment of the present disclosure includes an optimization processing unit 201, and a storage unit 202.

The optimization processing unit 201 executes processing (hereinafter, also represented as “optimization processing”) to optimize the target problem based on the framework of the Bayesian optimization. The storage unit 202 stores various data used in the optimization processing for the target problem (for example, a function model for which the estimated parameter has been set, or the like) and a processing result of the optimization processing of the target problem (for example, a point that gives the maximum value and the maximum value of the target function, or the like).

Here, in Bayesian optimization, the input used for the next evaluation is selected by an acquisition function. Accordingly, for example, the optimization processing unit 201 uses the expected improvement quantity illustrated in Equation (3) below as an acquisition function.

$$\begin{matrix}[ Math . 12 ] & \\ a ( x ) = ( μ ( x ) - {y}^{*} ) Φ ( \frac{μ ( x ) - {y}^{*}}{σ ( x )} ) + σ ( x ) ϕ ( \frac{μ ( x ) - {y}^{*}}{σ ( x )} ) & ( 3 )\end{matrix}$$

where φ(⋅) and Φ(⋅) represent the density function and the cumulative density function of the standard normal distribution, respectively; y* represents the maximum value that has been obtained previously (that is, the largest target function value among the target function values that have been evaluated previously); μ(x) represents the mean; and σ(x) represents the standard deviation. The optimization processing unit 201 may use an optional acquisition function other than the expected improvement quantity.

In a case where the target function f_{d*} has been evaluated for N_{d*} times previously, it is assumed that the previous input is

X*=(x_{d*n})ₙ₌₁^{N}^{_{d*}} and [Math. 13]

that the previous evaluation value (that is, the target function value) is

y*=(y_{d*n})ₙ₌₁^{N}^{_{d*}}. [Math. 14]

At the time, in a case where the neural Gaussian process illustrated in the above Equation (1) is used as a function model, the optimization processing unit 201 can calculate the distribution of the target function by the following Equations (4) to (5).

[Math. 15]

f_{d}*(x)|X*,y*,\hat{ξ},\hat{ψ},\hat{θ},\hat{β}˜ [symbol] (μ_{d*}(x),σ_{d*}²(x)) (4)

μ_{d*}(x)=m(x,r_{d*};\hat{ξ})+k_{*}^{T}(K_{*}+\hat{β}I)⁻¹(y*−m(x,r_{d*};\hat{ξ})) (5)

σ_{d*}²(x)=kₓ−k_{*}^{T}K_{*}⁻¹k_{*} (6)

where

kₓ=k(g(x,r_{d*};\hat{ψ}),g(x,r_{d*};\hat{ψ});\hat{θ}) [Math. 16]

is a kernel function value at x:

k_{*} [Math. 17]

is an N_{d*} dimensional vector of the kernel function value between x and X*;

K_{*} [Math. 18]

is a kernel matrix of X*; and

\hat{ξ},\hat{ψ},\hat{θ},\hat{β} [Math. 19]

is a parameter (that is, an estimated parameter) of the function model estimated by the parameter estimation processing unit 101.

Here, as illustrated in FIG. 1, the optimization processing unit 201 includes an input unit 211, a distribution estimation unit 212, an acquisition function calculation unit 213, a function evaluation unit 214, an end condition determination unit 215, and an output unit 216.

The input unit 211 inputs a function model for which the estimated parameter has been set. The input unit 211 may input the function model stored in the storage unit 202, or may receive and input the function model from other apparatuses connected via the communication network.

The distribution estimation unit 212 estimates the distribution of the target function by, for example, Equation (4) above. The acquisition function calculation unit 213 calculates an acquisition function (for example, the expected improvement quantity illustrated in Equation (3) above) using the distribution estimated by the distribution estimation unit 212. The function evaluation unit 214 evaluates the target function at a point where the value of the acquisition function calculated by the acquisition function calculation unit 213 becomes maximum (that is, obtains a target function value at that point).

The estimation of the distribution by the distribution estimation unit 212, the calculation of the acquisition function by the acquisition function calculation unit 213, and evaluation of the function by the function evaluation unit 214 are repeatedly executed until a predetermined end condition is satisfied. Hereinafter, the predetermined end condition is represented as a “second end condition”.

The end condition determination unit 215 determines whether the second end condition is satisfied. The second end condition includes, for example, that the number of repetitions has reached a predetermined number, that a maximum value of the target function is greater than or equal to a predetermined threshold value, that a change quantity of the maximum value of the target function is less than or equal to a predetermined threshold value, or the like.

In a case where the end condition determination unit 215 determines that the second end condition is satisfied, the output unit 216 outputs the processing result of the optimization processing (for example, a maximum value of the evaluation value (target function value) and a point giving the maximum value). The output unit 216 may output (store) the processing result of the optimization processing to the storage unit 202, or may output to other apparatuses connected via the communication network.

Here, in the embodiment of the present disclosure, although a case where the estimation apparatus 10 and the optimization apparatus 20 are different apparatuses, has been described, the estimation apparatus 10 and the optimization apparatus 20 may be implemented in a single apparatus. In the case, the apparatus may be configured to include the parameter estimation processing unit 101, the optimization processing unit 201, and the storage unit.

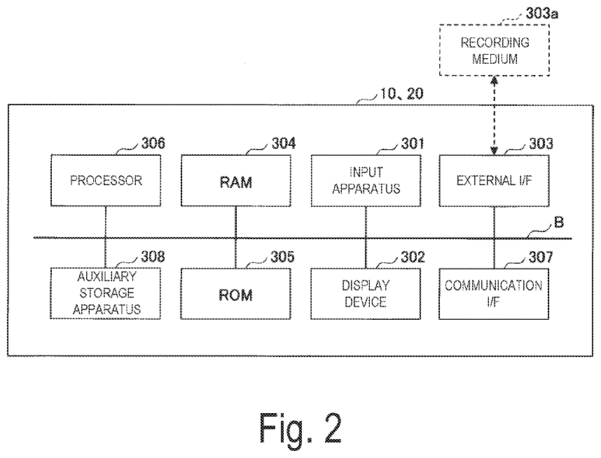

Hardware configuration of estimation apparatus 10 and optimization apparatus 20 Next, a hardware configuration of the estimation apparatus 10 and the optimization apparatus 20 according to the embodiment of the present disclosure will be described with reference to FIG. 2. FIG. 2 is a diagram illustrating an example of a hardware configuration of the estimation apparatus 10 and the optimization apparatus 20 according to the embodiment of the present disclosure. The estimation apparatus 10 and the optimization apparatus 20 can be implemented in a similar hardware configuration, and thus the hardware configuration of the estimation apparatus 10 will be mainly described hereinafter.

As illustrated in FIG. 2, the estimation apparatus 10 according to the embodiment of the present disclosure includes an input apparatus 301, a display device 302, an external I/F 303, a Random Access Memory (RAM) 304, a Read Only Memory (ROM) 305, a processor 306, a communication I/F 307, and an auxiliary storage apparatus 308. Each of the pieces of hardware is communicably connected via a bus B.

The input apparatus 301 is, for example, a keyboard, a mouse, a touch panel, or the like, and is used by the user to input various operations. The display device 302 is, for example, a display or the like, and displays the processing result of the estimation apparatus 10, or the like. The estimation apparatus 10 and the optimization apparatus 20 may not include at least one of the input apparatus 301 and the display device 302.

The external I/F 303 is an interface with an external apparatus. The external apparatus includes a recording medium 303a, or the like. The estimation apparatus 10 can read and write the recording medium 303a, or the like via the external I/F 303. One or more programs for implementing the parameter estimation processing unit 101, one or more programs that implement the optimization processing unit 201, or the like may be recorded in the recording medium 303a.

The recording medium 303a includes, for example, a flexible disk, a Compact Disc (CD), a Digital Versatile Disk (DVD), a Secure Digital memory card (SD memory card), a Universal Serial Bus (USB) memory card, or the like.

The RAM 304 is a volatile semiconductor memory that temporarily retains a program and data. The ROM 305 is a non-volatile semiconductor memory that can retain a program and data even when the power is turned off. The ROM 305 stores, for example, setting information related to an operating system (OS), setting information related to a communication network, or the like.

The processor 306 is, for example, a Central Processing Unit (CPU), a Graphics Processing Unit (GPU), or the like, and is an operation apparatus that reads a program or data from the ROM 305, the auxiliary storage apparatus 308, or the like onto the RAM 304 to execute processing. The parameter estimation processing unit 101 is implemented by reading one or more programs stored in the ROM 305, the auxiliary storage apparatus 308, or the like onto the RAM 304, and executing processing by the processor 306. Similarly, the optimization processing unit 201 is implemented by reading one or more programs stored in the ROM 305, the auxiliary storage apparatus 308, or the like onto the RAM 304, and executing processing by the processor 306.

The communication I/F 307 is an interface to connect the estimation apparatus 10 to a communication network. One or more programs that implement the parameter estimation processing unit 101 and one or more programs that implement the optimization processing unit 201 may be acquired (downloaded) from a predetermined server apparatus or the like via the communication I/F 307.

The auxiliary storage apparatus 308 is, for example, a Hard Disk Drive (HDD), a Solid State Drive (SSD), or the like, and is a non-volatile storage apparatus that stores a program and data. The program and data stored in the auxiliary storage apparatus 308 include, for example, an OS, an application program that implements various functions on the OS, or the like. Additionally, the auxiliary storage apparatus 308 of the estimation apparatus 10 stores one or more programs that implement the parameter estimation processing unit 101. Similarly, one or more programs that implement the optimization processing unit 201 are stored in the auxiliary storage apparatus 308 of the optimization apparatus 20.

Additionally, the storage unit 102 included in the estimation apparatus 10 can be implemented by using, for example, the auxiliary storage apparatus 308. Similarly, the storage unit 202 included in the optimization apparatus 20 can be implemented by using, for example, the auxiliary storage apparatus 308.

The estimation apparatus 10 according to the embodiment of the present disclosure has the hardware configuration illustrated in FIG. 2 and thus can implement various processing described below. Similarly, the optimization apparatus 20 according to the embodiment of the present disclosure has the hardware configuration illustrated in FIG. 2 and thus can implement various processing described below.

In the example illustrated in FIG. 2, although a case where each of the estimation apparatus 10 and the optimization apparatus 20 according to the embodiment of the present disclosure is implemented by one apparatus (computer), is illustrated, the present disclosure is not limited to the case. At least one of the estimation apparatus 10 and the optimization apparatus 20 according to the embodiment of the present disclosure may be implemented by a plurality of apparatuses (computers). Additionally, a plurality of processors 306 and a plurality of memories (the RAM 304 and the ROM 305, auxiliary storage apparatus 308, or the like) may be included in one apparatus (computer).

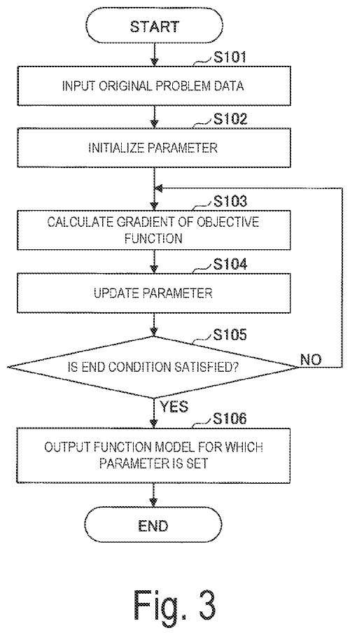

Parameter Estimation Processing Next, the parameter estimation processing according to the embodiment of the present disclosure will be described with reference to FIG. 3. FIG. 3 is a flowchart illustrating an example of parameter estimation processing according to the embodiment of the present disclosure.

First, the input unit 111 inputs the original problem data (step S101).

Next, the initialization unit 112 initializes the parameter of the function model (for example, the parameters ξ, θ, and ψ described above) (step S102). The initialization unit 112 initializes the parameter described above to an appropriate value in accordance with the problem d to be optimized.

Next, the gradient calculation unit 113 calculates the gradient of the objective function (for example, the likelihood illustrated in Equation (2) above) (step S103).

Next, the parameter update unit 114 updates the parameter of the function model so that the value of the objective function increases using the gradient calculated by the gradient calculation unit 113 (step S104).

Next, the end condition determination unit 115 determines whether the first end condition is satisfied (step S105).

In accordance with a determination in the step S105 that the first end condition is not satisfied, the parameter estimation processing unit 101 returns to the step S103. Accordingly, the steps S103 to S104 are repeatedly performed until the first end condition is satisfied.

On the other hand, in accordance with a determination in the step S105 that the first end condition is met, the output unit 116 outputs the parameter of the function model (that is, the estimated parameter) (step S106).

Optimization Processing

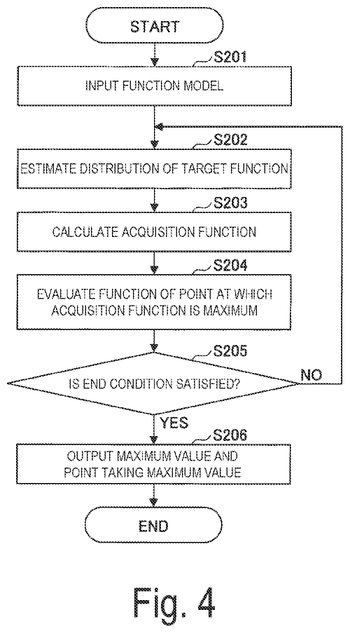

Next, the optimization processing (optimization processing of the target problem) according to the embodiment of the present disclosure will be described with reference to FIG. 4. FIG. 4 is a flowchart illustrating an example of optimization processing according to the embodiment of the present disclosure.

First, the input unit 211 inputs a function model for which the estimated parameter has been set (step S201).

Next, the distribution estimation unit 212 estimates the distribution of the target function (step S202). For example, in a case where the neural Gaussian process illustrated in the above Equation (1) is used as the function model, the distribution estimation unit 212 estimates the distribution of the target function by the above Equations (4) to (5).

Next, the acquisition function calculation unit 213 calculates an acquisition function (for example, the expected improvement quantity illustrated in Equation (3) above) using the distribution estimated by the distribution estimation unit 212 (step S203).

Next, the function evaluation unit 214 evaluates the target function at a point where the value of the acquisition function calculated by the acquisition function calculation unit 213 becomes maximum (step S204).

Next, the end condition determination unit 215 determines whether the second end condition is satisfied (step S205).

In accordance with a determination in the step S205 that the second end condition is not satisfied, the optimization processing unit 201 returns to the step S202. Accordingly, the step S202 to the step S204 are repeatedly performed until the second end condition is satisfied.

On the other hand, in accordance with a determination in the step S205 that the second end condition is satisfied, the output unit 216 outputs the processing result of the optimization processing (for example, a maximum value of the target function and a point giving the maximum value) (step S206). The output unit 216 may output only a maximum value of the evaluation value, may output only the point giving the maximum value, or may output both of the maximum value and the point.

Comparison Result with Technology in Related Art

Next, the comparison result between the present disclosure and technology in related art will be described. Here, three types of the optimization problems used for the comparison include “artificial optimization problem”, “optimal human flow navigation search”, and “optimal machine learning device search”. In a case where the three types of the optimization problems are solved, the average number of evaluations and standard errors until an optimal value (maximum value or minimum value) is found is shown in Table 1 below.

TABLE 1

| | PROBLEM | | |
|---|---|---|---|
| | | OPTIMAL | OPTIMAL |
| | ARTIFICIAL | HUMAN | MACHINE |
| | OPTIMIZA- | FLOW | LEARNING |
| | TION | NAVIGATION | DEVICE |
| METHOD | PROBLEM | SEARCH | SEARCH |
| PRESENT | 9.00 ± 1.85* | 18.16 ± 0.81* | 60.40 ± 1.58* |
| DISCLOSURE-RMK | | | |
| PRESENT | 19.50 ± 3.78 | 22.53 ± 0.90 | 61.19 ± 1.63* |
| DISCLOSURE-RM | | | |
| PRESENT | 25.65 ± 2.75 | 23.38 ± 0.82 | 62.87 ± 1.52* |
| DISCLOSURE-RK | | | |
| PRESENT | 25.85 ± 2.40 | 19.82 ± 0.66 | 61.32 ± 1.64* |
| DISCLOSURE-MK | | | |
| GP | 71.05 ± 30.04 | 42.30 ± 1.00 | 78.59 ± 1.85 |
| TGP | 27.95 ± 3.39 | 31.16 ± 0.85 | 88.00 ± 1.56 |
| NP | 147.95 ± 18.42 | 162.37 ± 3.61 | 76.92 ± 1.87 |
| NN | 192.40 ± 19.12 | 172.57 ± 3.99 | 83.95 ± 1.83 |
| NN-R | 66.45 ± 12.28 | 35.41 ± 1.20 | 70.05 ± 1.80 |
| Random | 333.40 ± 30.92 | 565.52 ± 5.95 | 107.79 ± 1.77 |

Here, four types of versions of RMK, RM, RK, and MK are used in the present disclosure. R represents using a feature (that is, a feature is given to each optimization problem and the feature is used), M represents using a neural network as an average function, and K represents using a neural network as a kernel function.

For example, “present disclosure-RMK” illustrates a case where the optimization problem is solved by the method of the present disclosure using a feature, and using a neural network as the average function m and a neural network as the input of the kernel function k. Similarly, for example, “present disclosure-RM” illustrates a case where the optimization problem is solved by the method of the present disclosure using a feature, and using a neural network as the average function m and a function other than a neural network as the kernel function k. The same applies to the “present disclosure-RK” and “present disclosure-MK”.

Additionally, as the technology in related art, a Gaussian process (GP), a Gaussian process (TGP) in which the kernel parameter is learned in the original problem, a neural process (NP), a neural network (NN), a neural network using a feature (NN-R), and a method to randomly choose a point used for the next evaluation, are used.

As shown in Table 1 above, it can be seen that the method of the present disclosure can find an optimal value with a fewer number of evaluations than other technology in related art (that is, more efficiently than in the technology in related art). In Table 1 above, the method in which the average number of evaluations is best (that is, present disclosure-RMK) is illustrated in bold. Additionally, the cases with no statistically significant differences from the best method are given an asterisk “*”.

The present disclosure is not limited to the above-described embodiment specifically disclosed, and various modifications and changes can be made without departing from the scope of the claims.

### REFERENCE SIGNS LIST

10 Estimation apparatus
20 Optimization apparatus
101 Parameter estimation processing unit
111 Input unit
112 Initialization unit
113 Gradient calculation unit
114 Parameter update unit
115 End condition determination unit
116 Output unit
102 Storage unit
201 Optimization processing unit
202 Storage unit
211 Input unit
212 Distribution estimation unit
213 Acquisition function calculation unit
214 Function evaluation unit
215 End condition determination unit
216 Output unit

1. An estimation apparatus, comprising:
a receiver configured to receive data related to a plurality of optimization problems; and
an estimator configured to estimate a parameter of a function model that models a function to be optimized in each of the plurality of optimization problems.

2. The estimation apparatus according to claim 1, wherein the estimator is further configured to:
determine a gradient of an objective function according to the function model and the data, and
estimate the parameter of the function model using the gradient so that a value of the objective function is at a maximum or a minimum.

3. An optimization apparatus, comprising:
a receiver configured to receive a function model that models a function to be optimized in each of a plurality of optimization problems; and
an optimizer configured to optimize a target function by repeatedly evaluating the target function to be optimized in an optimization problem different from each of the plurality of optimization problems, using the function model.

4. The optimization apparatus according to claim 3, wherein the optimizer is further configured to:
determine a distribution of the target function using a parameter of the function model, and
evaluate the target function with a value determined by a predetermined acquisition function, using the distribution.

5. The optimization apparatus according to claim 3, the apparatus further comprising:
an estimator configured to estimate a parameter of a function model that models a function to be optimized in each of the plurality of optimization problems, wherein
the optimizer optimizes the target function by repeatedly evaluating the target function to be optimized in the optimization problem different from each of the plurality of optimization problems, using the function model for which the estimated parameter is set.

6. A method comprising, at a computer:
receiving, by a receiver, data related to a plurality of optimization problems; and
estimating, by an estimator, a parameter of a function model that models a function to be optimized in each of the plurality of optimization problems.

7. The method according to claim 6, the method further comprising:
receiving, by the receiver, the function model that models a function to be optimized in each of a plurality of optimization problems; and
optimizing, by an optimizer, a target function by repeatedly evaluating the target function to be optimized in an optimization problem different from each of the plurality of optimization problems, using the function model.

8. (canceled)

9. The estimation apparatus according to claim 1, wherein the plurality of optimization problems corresponds to determining either a first point taking a maximum value or a second point taking a minimum value of the function

10. The estimation apparatus according to claim 1, wherein the function model that models a function to be optimized is associated with Bayesian optimization.

11. The optimization apparatus according to claim 3, wherein the plurality of optimization problems corresponds to determining either a first point taking a maximum value or a second point taking a minimum value of the function.

12. The optimization apparatus according to claim 3, wherein the function model that models a function to be optimized is associated with Bayesian optimization.

13. The method according to claim 6, wherein the plurality of optimization problems corresponds to determining either a first point taking a maximum value or a second point taking a minimum value of the function.

14. The method according to claim 6, wherein the function model that models a function to be optimized is associated with Bayesian optimization.

15. The method according to claim 6, further comprising:
determining a gradient of an objective function according to the function model and the data, and
estimating the parameter of the function model using the gradient so that a value of the objective function is at a maximum or a minimum.

16. The method according to claim 7, further comprising:
determining a distribution of the target function using a parameter of the function model, and
evaluating the target function with a value determined by a predetermined acquisition function, using the distribution.

17. The method according to claim 7, further comprising:
estimating, by an estimator, a parameter of a function model that models a function to be optimized in each of the plurality of optimization problems, wherein the optimizer optimizes the target function by repeatedly evaluating the target function to be optimized in the optimization problem different from each of the plurality of optimization problems, using the function model for which the estimated parameter is set.
